(19) United States
(12) Patent Application Publication
(10) Pub. No.: US 2010/0090988 A1
(43) Pub. Date: Apr. 15, 2010

(54) Stylus Pen

(76) Inventor: Min Hong PARK, Seoul (KR)

Correspondence Address: IPHORGAN, LTD., 1130 LAKE COOK ROAD, SUITE 240, BUFFALO GROVE, IL, 60089, US

(21) Appl. No.: 12/475,774

(22) Filed: Jun. 1, 2009

(30) Foreign Application Priority Data
Oct. 15, 2008 (KR) 10-2008-0101096

(51) Int. Cl. G06F 3/033

(52) U.S. Cl. 345/179; 178/19.01

(57) ABSTRACT

Provided is a stylus pen including: first and second touch pen portions, each of which includes a touch part at an end thereof; and a coupling portion linking the first and second touch pen portions so that the first and second touch pen portions are rotatably moved with respect to each other to adjust a spatial distance between the touch parts of the first and second touch pen portions.

### CROSS-REFERENCE TO RELATED APPLICATION

This application claims the benefit of Korean Patent Application No. 10-2008-0101096, filed on Oct. 15, 2008, the disclosure of which is incorporated herein by reference.

### BACKGROUND OF THE INVENTION

1. Field of the Invention

The present invention relates to a stylus pen, and more particularly, to a stylus pen for operating a touch screen of a portable electronic apparatus.

2. Description of the Related Art

Generally, a stylus pen is an input device of a portable apparatus with a touch screen, such as a personal digital assistant (PDA), a cellular phone, and a portable multimedia player (PMP). When a user touches a touch screen of a portable apparatus with a stylus pen nib, the portable apparatus detects the position of the stylus pen nib on the touch screen, and performs an operation corresponding to the position of the stylus pen.

In past years, a technique detecting only one touch point position of a stylus pen on a touch screen and performing an operation according to the detected position was used. In recent years, however, a multi-touch technique has been proposed for detecting two or more touch point positions on a touch screen and performing operations according to the detected positions. For example, it is possible to control the sizes of windows on a graphic user interface by simultaneously selecting the lower right and upper left points of the windows. Therefore, a stylus pen for simultaneously selecting two or more touch point positions on a touch screen is required.

### SUMMARY OF THE INVENTION

The present invention provides a stylus pen capable of simultaneously selecting two or more touch point positions on a touch screen.

According to an aspect of the present invention, there is provided a stylus pen including: first and second touch pen portions, each of which includes a touch part at an end thereof; and a coupling portion linking the first and second touch pen portions so that the first and second touch pen portions are rotatably moved with respect to each other to adjust a spatial distance between the touch parts of the first and second touch pen portions.

### BRIEF DESCRIPTION OF THE DRAWINGS

These and/or other aspects and advantages of the invention will become apparent and more readily appreciated from the following description of the embodiments taken in conjunction with the accompanying drawings of which:

FIG. 1 is a perspective view of a stylus pen according to an exemplary embodiment of the present invention

FIG. 2 is an exploded perspective view of a stylus pen according to another embodiment of the present invention;

FIG. 3 is a perspective view of the stylus pen of FIG. 2;

FIG. 4 is a view illustrating a modified embodiment of the stylus pen of FIG. 2;

FIG. 5 is a view illustrating a stylus pen according to a modified embodiment of FIG. 1 or 2, including an elastic member for elastically supporting first and second touch pen portions to open the two touch pen portions at a predetermined angle;

FIG. 6 is a perspective view of a stylus pen according to another modified embodiment of FIG. 1 or 2, including another elastic member for elastically supporting first and second touch pen portions to open the two touch pen portions at a predetermined angle;

FIG. 7 is an exploded perspective view of a stylus pen according to still another modified embodiment of FIG. 1 or 2, wherein first and second touch pen portions are rotatably moved with respect to each other and stopped successively by every predetermined angle;

FIG. 8 is a view illustrating a stylus pen according to still another embodiment of the present invention;

FIG. 9 is a sectional view illustrating an embodiment of an elastic member for elastically supporting first and second touch pen portions of the stylus pen of FIG. 8 to maintain the two touch pen portions at an angle of 180 degrees;

FIG. 10 is a sectional view taken along a line X-X of FIG. 8, illustrating another embodiment of an elastic member for elastically supporting first and second touch pen portions of the stylus pen of FIG. 8 to maintain the two touch pen portions at an angle of 180 degrees;

FIG. 11 is a view illustrating a stylus pen according to still another embodiment of the present invention;

FIG. 12 is a view illustrating a modified embodiment of the stylus pen of FIG. 11;

FIG. 13 is a view illustrating an operation of a slide member of the stylus pen of FIG. 12;

FIG. 14 is a view illustrating touch parts according to another embodiment of the present invention; and

FIG. 15 is a perspective view of a stylus pen according to a further embodiment of the present invention.

### DETAILED DESCRIPTION OF THE INVENTION

The present invention will now be described more fully with reference to the accompanying drawings, in which exemplary embodiments of the invention are shown.

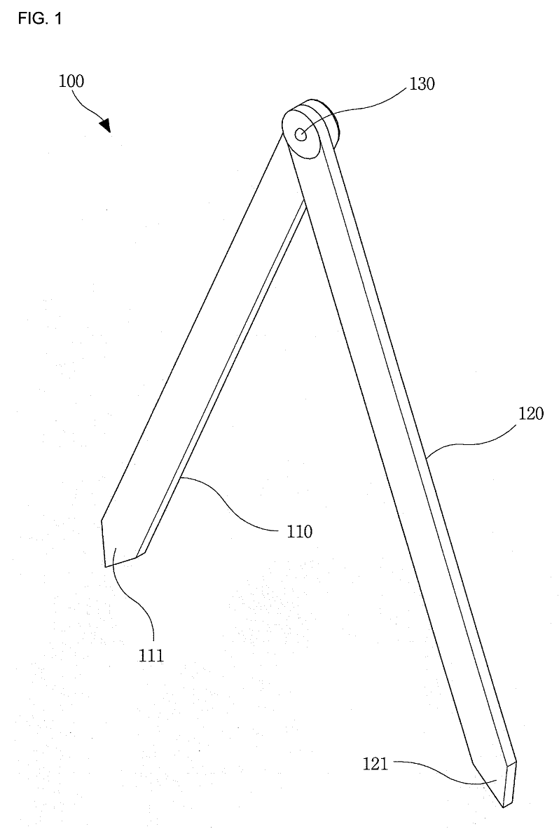

FIG. 1 is a perspective view of a stylus pen according to an exemplary embodiment of the present invention.

Referring to FIG. 1, a stylus pen 100 according to an exemplary embodiment of the present invention includes first and second touch pen portions 110 and 120, and a coupling portion 130.

The first and second touch pen portions 110 and 120 have respective touch parts 111 and 121 at ends thereof. The touch parts 111 and 121 may have pointed ends to press any touch point position of a touch screen when they are contacted to the touch screen.

The first and second touch pen portions 110 and 120 are rotatably linked to each other by the coupling portion 130. The rotary movement of the first and second touch pen portions 110 and 120 enables to adjust a spatial distance between the touch parts 111 and 121. That is, the coupling portion 130 links an end (an upper end in FIG. 1) of the first touch pen portion 110 to an end (an upper end in FIG. 1) of the second touch pen portion 120 so that the first and second touch pen portions 110 and 120 are rotatably moved with respect to each other.

A user can simultaneously select two touch point positions on a touch screen using the stylus pen 100 having the above-described structure by adjusting a spatial distance between the touch parts 111 and 121.

FIG. 1 illustrates that the stylus pen 100 includes the two touch pen portions 110 and 120 to simultaneously select two touch point positions on a touch screen, but the present invention is not limited thereto. That is, the stylus pen 100 may further include a third touch pen portion rotatably linked to the first and second touch pen portions 110 and 120 to simultaneously select three touch point positions on a touch screen.

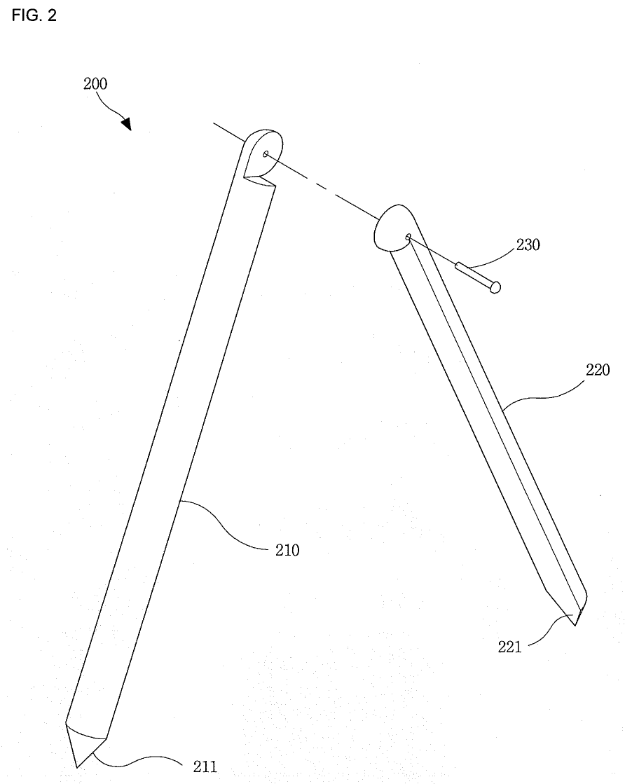

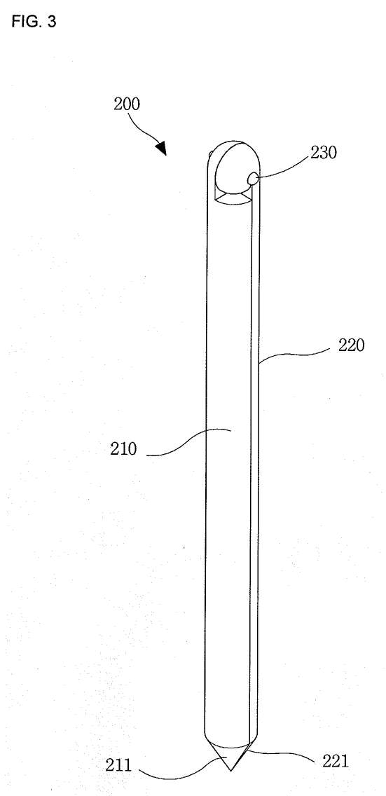

Meanwhile, a stylus pen according to another embodiment of the present invention may be structured such that when first and second touch pen portions are integrally joined together, touch parts form a common pointed tip. A detailed description thereof will now be provided with reference to FIGS. 2 and 3.

FIG. 2 is an exploded perspective view of a stylus pen according to another embodiment of the present invention, and FIG. 3 is a perspective view of the stylus pen of FIG. 2.

Referring to FIGS. 2 and 3, a stylus pen 200 according to another embodiment of the present invention may be structured such that when first and second touch pen portions 210 and 220 are integrally joined together, touch parts 211 and 221 form a common tip. Specifically, for example, each of the first and second touch pen portions 210 and 220 may have a shape obtained by dividing a cylinder into halves along its major axis. That is, each of the first and second touch pen portions 210 and 220 may have a semi-circular cross-section, and each of the touch parts 211 and 221 may have a shape obtained by dividing a cone into halves along its major axis. Thus, when the first and second touch pen portions 210 and 220 are joined together, a cylinder configuration with a conical-shaped end may be formed. A user may select two touch point positions on a multi-touch functional touch screen while maintaining a predetermined spatial distance between the touch parts 211 and 221 of the stylus pen 200. Alternatively, a user may also select only one touch point position on the touch screen using a common pen tip formed by joining the touch parts 211 and 221, as shown in FIG. 3.

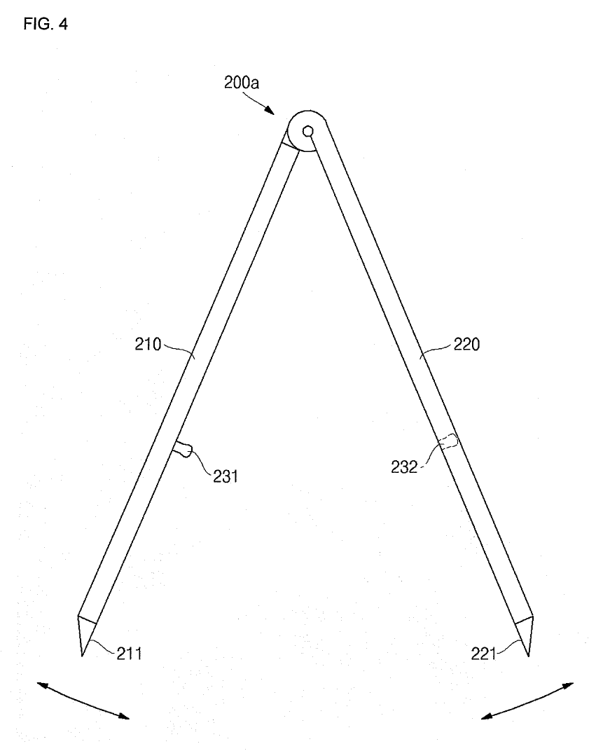

Meanwhile, the stylus pen 200 may also be structured such that the first touch pen portion 210 includes a locking protrusion and the second touch pen portion 220 includes a locking groove. A detailed description thereof will now be provided with reference to FIG. 4.

FIG. 4 is a view illustrating a stylus pen 200a according to a modified embodiment of FIG. 2.

Referring to FIG. 4, a locking protrusion 231 is formed at a first touch pen portion 210 to protrude toward a second touch pen portion 220 from a surface of the first touch pen portion 210 facing the second touch pen portion 220. A locking groove 232 is formed at a position of the second touch pen portion 220 corresponding to the locking protrusion 231 to receive the locking protrusion 231.

The locking protrusion 231 and the locking groove 232 are responsible for fixedly closing the first and second touch pen portions 210 and 220. Thus, when the stylus pen 200a is carried on hands, the first and second touch pen portions 210 and 220 are not opened unless an external force of a predetermined magnitude or greater is applied thereto. The locking protrusion 231 may be made of a ductile material so as to be easily inserted into the locking groove 232.

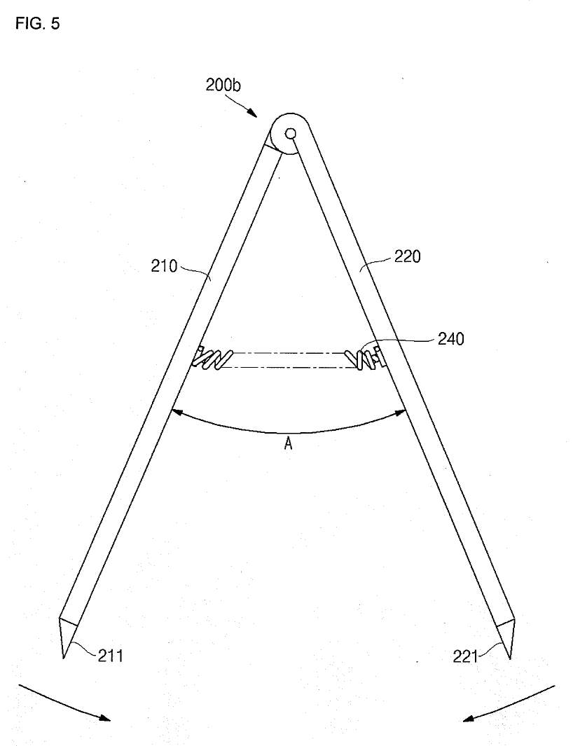

A stylus pen as shown in FIG. 1 or 2 may further include a compression spring. A detailed description thereof will now be provided with reference to FIG. 5.

FIG. 5 is a view illustrating a stylus pen 200b wherein first and second touch pen portions 210 and 220 are opened at a predetermined angle and elastically supported by a compression spring 240.

Referring to FIG. 5, both ends of the compression spring 240 are fixedly connected to the positions of the first and second touch pen portions 210 and 220 that are away from the rotation center. The compression spring 240 is responsible for opening the first and second touch pen portions 210 and 220 at a predetermined angle A. Thus, the first and second touch pen portions 210 and 220 can be maintained at an angle more than zero degrees due to the compression spring 240 even when an external force such as a user's grip pressure is applied thereto.

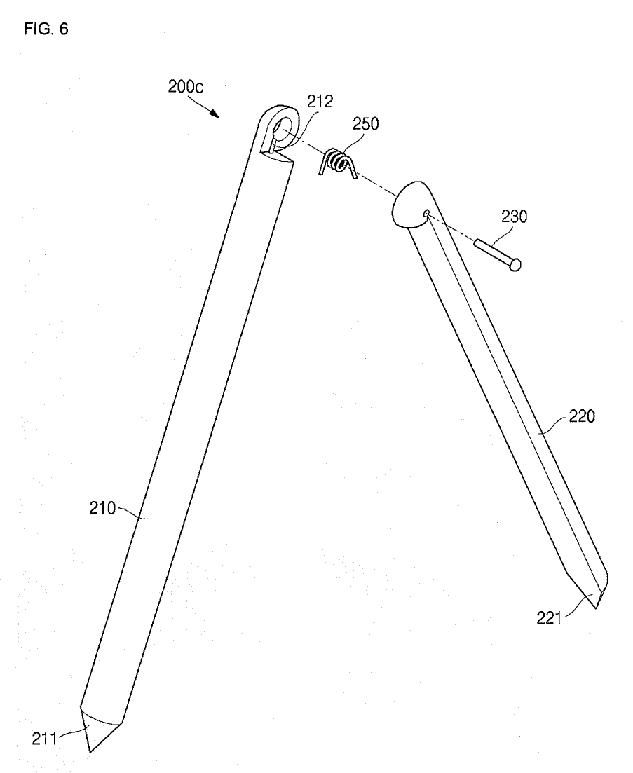

A stylus pen as shown in FIG. 1 or 2 may further include a torsion spring, instead of a compression spring, to open first and second touch pen portions at a predetermined angle and to elastically support the two touch pen portions. A detailed description thereof will now be provided with reference to FIG. 6.

FIG. 6 is a perspective view of a stylus pen 200c wherein first and second touch pen portions 210 and 220 are opened at a predetermined angle and elastically supported by a torsion spring 250.

Referring to FIG. 6, the torsion spring 250 is disposed around a coupling portion 230 and both ends of the torsion spring 250 are fixedly connected to the first and second touch pen portions 210 and 220. In more detail, an end of the torsion spring 250 is inserted into a groove 212 of the first touch pen portion 210, and the other end of the torsion spring 250 is inserted into a groove (not shown) of the second touch pen portion 220. Even when a spatial distance between the first and second touch pen portions 210 and 220 is decreased due to an external force, e.g., a user's grip pressure, and thus, the torsion spring 250 is distorted, an angle between the first and second touch pen portions 210 and 220 may be restored to its original value due to the elasticity of the torsion spring 250.

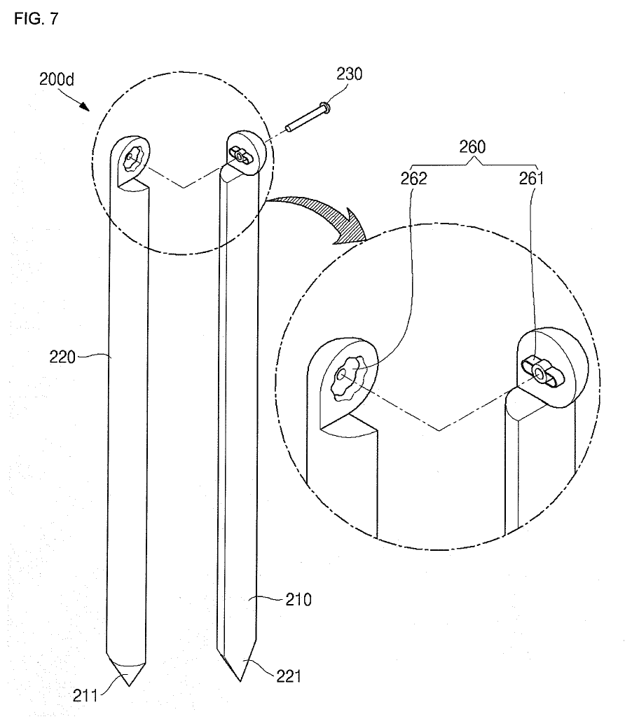

A stylus pen as shown in FIG. 1 or 2 may further include an angle retention member. A detailed description thereof will now be provided with reference to FIG. 7.

FIG. 7 is an exploded perspective view of a stylus pen 200d according to still another modified embodiment of FIG. 1 or 2, wherein first and second touch pen portions 210 and 220 are rotatably moved with respect to each other and stopped successively by every predetermined angle.

Referring to FIG. 7, an angle retention member 260 includes a protrusion portion 261 and a groove portion 262.

The protrusion portion 261 may be formed at a surface of the first touch pen portion 210 facing the second touch pen portion 220. The protrusion portion 261 may extend outwardly from the circumference of the rotation center of the first touch pen portion 210 and be elastically deformed to be elastically received in the groove portion 262.

The groove portion 262 may have a plurality of grooves formed at a predetermined pitch along an inner wall of a hollow space about the rotation center of the second touch pen portion 220 to safely receive the protrusion portion 261 whenever the first and second touch pen portions 210 and 220 are rotatably moved with respect to each other by a predetermined angle. That is, the protrusion portion 261 is rotated together with the first touch pen portion 210, the groove portion 262 is rotated together with the second touch pen portion 220, and the protrusion portion 261 is movably mounted in the grooves of the groove portion 262 whenever the first and second touch pen portions 210 and 220 are rotatably moved with respect to each other by a predetermined angle. Thus, the first and second touch pen portions 210 and 220 may be rotatably moved with respect to each other and stopped successively by every predetermined angle. This is advantageous when a user moves the stylus pen 200d on a touch screen while opening the first and second touch pen portions 210 and 220 at a predetermined angle using the angle retention member 260.

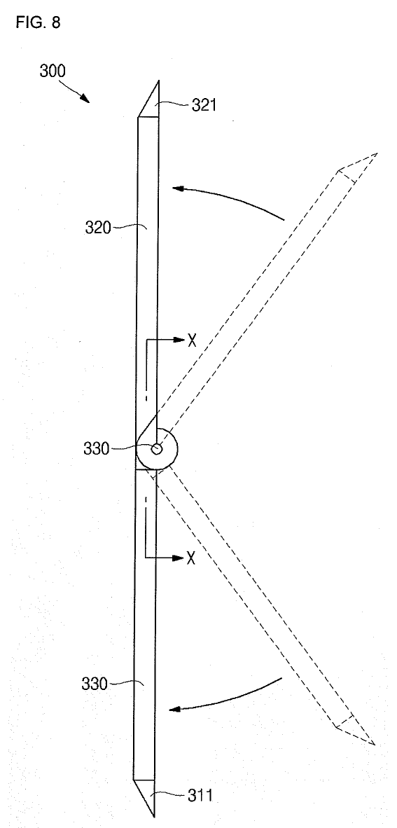

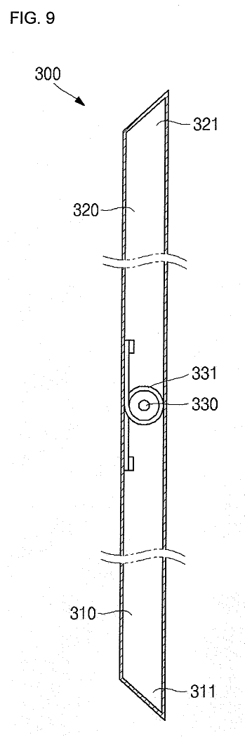

A stylus pen according to still another embodiment of the present invention may be structured such that first and second touch pen portions are elastically supported to be maintained at an angle of 180 degrees. A detailed description thereof will now be provided with reference to FIGS. 8 and 9.

FIG. 8 is a view illustrating a stylus pen according to still another embodiment of the present invention, and FIG. 9 is a sectional view of the stylus pen of FIG. 8 wherein first and second touch pen portions are elastically supported to be maintained at an angle of 180 degrees.

Referring to FIGS. 8 and 9, a stylus pen 300 includes a coupling portion 330 including a torsion spring 331 for maintaining first and second touch pen portions 310 and 320 at an angle of 180 degrees.

The torsion spring 331 is structured such that both ends thereof are maintained at an angle of 180 degrees, unlike the above-described torsion spring. The torsion spring 331 is disposed around the coupling portion 330, and both ends of the torsion spring 331 are fixedly connected to the first and second touch pen portions 310 and 320. Even when a spatial distance between the first and second touch pen portions 310 and 320 is decreased due to an external force, e.g., a user's grip pressure, and thus, the torsion spring 331 is distorted, an angle between the first and second touch pen portions 310 and 320 may be restored to its original value (i.e., an angle of 180 degrees) due to the elasticity of the torsion spring 331. A user may use the stylus pen 300 having the above-described structure by rotatably moving the first and second touch pen portions 310 and 320 with respect to each other so that touch parts 311 and 321 come close to each other. On the other hand, after use, a user may insert and store the stylus pen 300 in a receiving space of a portable apparatus (not shown) while maintaining the first and second touch pen portions 310 and 320 at an angle of 180 degrees. Further, a user may select only one touch point position on a touch screen while maintaining the first and second touch pen portions 310 and 320 at an angle of 180 degrees.

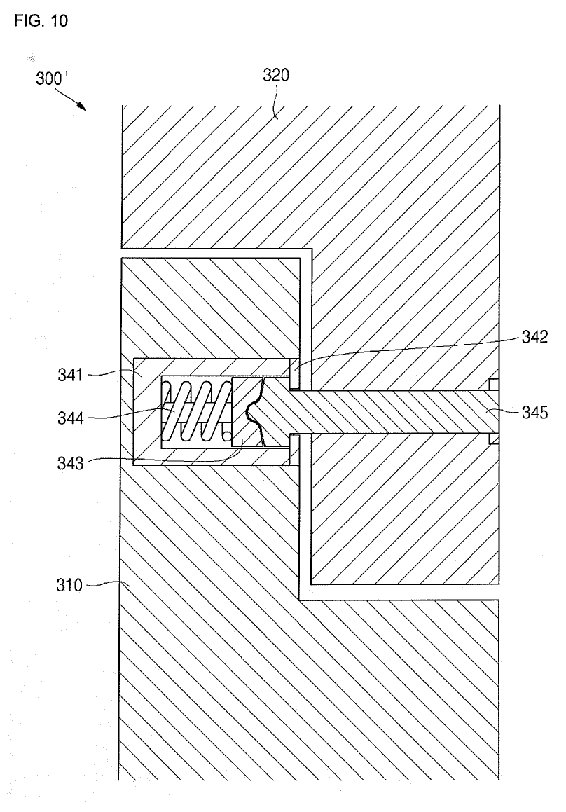

Meanwhile, the coupling portion 330 may also include a hinge module, instead of a torsion spring, to maintain the first and second touch pen portions 310 and 320 at an angle of 180 degrees. A detailed description thereof will now be provided with reference to FIG. 10.

FIG. 10 is a sectional view taken along a line X-X of FIG. 8, illustrating a stylus pen 300′ that first and second touch pen portions 310 and 320 are maintained at an angle of 180 degrees and elastically supported by a hinge module.

Referring to FIG. 10, the hinge module includes a hinge case 341, a drive cam 343, an elastic spring 344, and a shaft 345.

The hinge case 341 has an internal space with an opening on a side thereof and is fixedly joined to the first touch pen portion 310.

The drive cam 343 is disposed in the hinge case 341, and a rotation angle between the first and second touch pen portions 310 and 320 is determined according to the profile (not shown) of the drive cam 343.

The elastic spring 344 is interposed between the drive cam 343 and an inner wall of the hinge case 341 to elastically support the drive cam 343 in one direction.

The shaft 345 is structured such that a side of the shaft 345 is contacted to the drive cam 343 in the hinge case 341, and the other side is fixedly joined to the second touch pen portion 320 and rotated together with the second touch pen portion 320. The hinge case 341 may further include an anti-dislodging cap 342 to prevent the separation of the shaft 345 from the hinge case 341.

In the above-described hinge module, the profile of the drive cam 343 may be formed so that the first and second touch pen portions 310 and 320 are optionally rotatably moved within an angle range of 0 to less than 90 degrees with respect to each other by an external force, whereas they are opened at an angle of 180 degrees when rotatably moved at an angle of 90 degrees or more with respect to each other.

Therefore, a user may simultaneously select two touch point positions on a touch screen using the stylus pen 300′ by optionally changing an angle between the first and second touch pen portions 310 and 320 within a range of 0 to less than 90 degrees. On the other hand, after use, a user may insert and store the stylus pen 300′ in a receiving space of a portable apparatus (not shown) while maintaining the first and second touch pen portions 310 and 320 at an angle of 180 degrees.

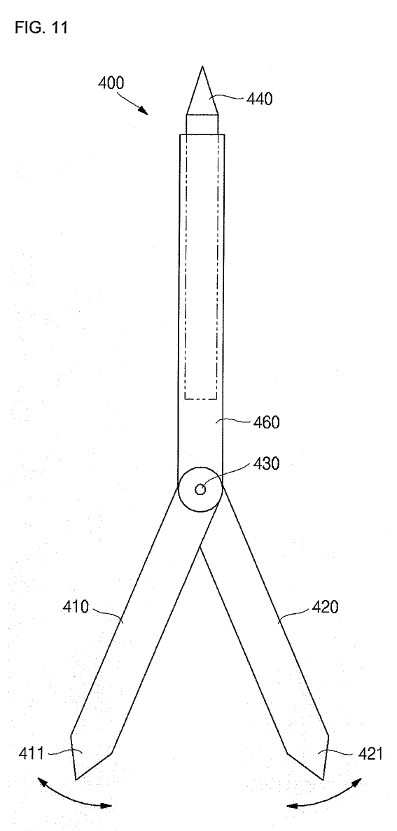

Meanwhile, a stylus pen according to still another embodiment of the present invention may further include an extension portion. A detailed description thereof will now be provided reference to FIG. 11.

FIG. 11 is a view illustrating a stylus pen 400 according to still another embodiment of the present invention.

Referring to FIG. 11, an extension portion 460 is linked to a coupling portion 430, coaxially with respect to first and second touch pen portions 410 and 420, and thus, the extension portion 460 and the first and second touch pen portions 410 and 420 are rotatably moved with respect to each other. Here, the first and second touch pen portions 410 and 420 may be formed to a shorter length, as compared with the stylus pens of the previous embodiments. Such a stylus pen 400 is advantageous to a user having relatively small hands because the first and second touch pen portions 410 and 420 have a small rotational radius and the extension portion 460 compensates for the decreased length of the first and second touch pen portions 410 and 420. Moreover, the extension portion 460 may has an open end to insert a writing instrument 440, such as a pencil or a ballpoint pen, into the extension portion 460 via the open end.

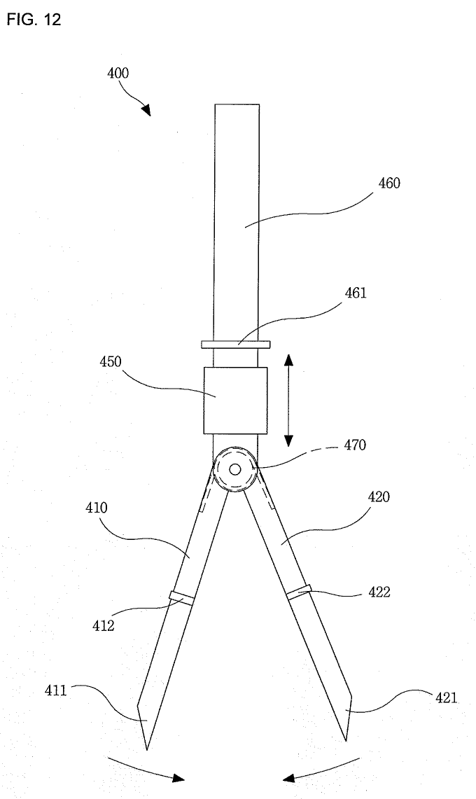

The stylus pen 400 may further include a slide member 450. A detailed description thereof will now be provided with reference to FIG. 12.

FIG. 12 is a view illustrating a stylus pen 400a according to a modified embodiment of FIG. 11.

Referring to FIG. 12, a slide member 450 is disposed to be slidably moved onto an extension portion 460 and first and second touch pen portions 410 and 420. The first and second touch pen portions 410 and 420 may be fully closed through the slidable movement of the slide member 450 onto the first and second touch pen portions 410 and 420. Here, the first and second touch pen portions 410 and 420 and the extension portion 460 may further include respective locking protrusions 412, 422, and 461 to prevent the separation of the slide member 450 from the first and second touch pen portions 410 and 420 and the extension portion 460.

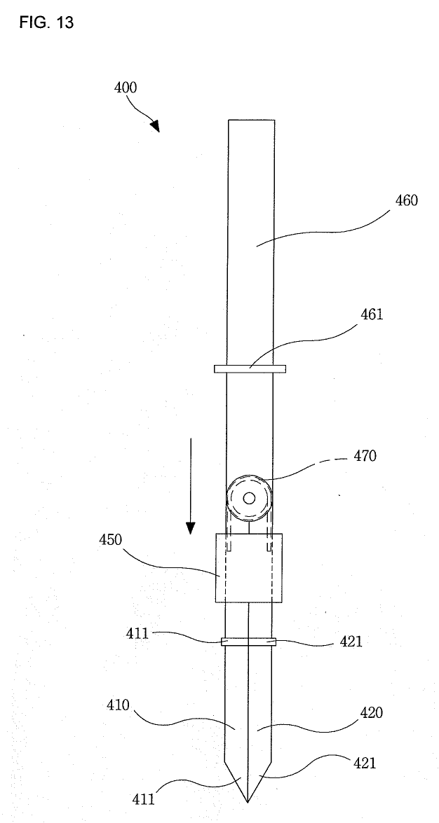

The stylus pen 400a may further include a torsion spring. In this respect, referring to FIG. 13, a stylus pen 400b includes a torsion spring 470 for maintaining first and second touch pen portions 410 and 420 at a predetermined angle. When a user wants to simultaneously touch two touch point positions on a touch screen with the stylus pen 400b, a slide member 450 may be slidably moved onto an extension portion 460 to open the first and second touch pen portions 410 and 420. On the other hand, when a user wants to touch only one touch point position on the touch screen with the stylus pen 400b or to carry the stylus pen 400b, the slide member 450 may be slidably moved onto the first and second touch pen portions 410 and 420, as shown in FIG. 13.

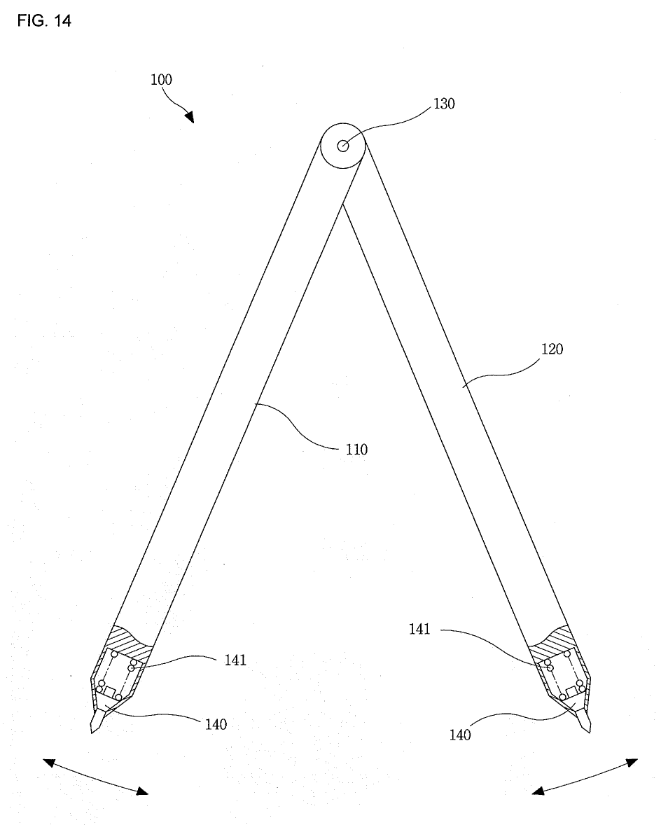

Meanwhile, the stylus pens of the previous embodiments may include an elastic pin as a modified embodiment of the touch parts. A detailed description thereof will now be provided with reference to FIG. 14.

FIG. 14 is a view illustrating a stylus pen 100a including touch parts modified from the previous embodiments.

Referring to FIG. 14, an elastic pin 140 is disposed at an end of at least one of first and second touch pen portions 110 and 120 to be elastically supported on the end. In more detail, a space is formed at an end of at least one of the first and second touch pen portions 110 and 120, and the elastic pin 140 is disposed in the space to be slidably moved toward or away from a coupling portion 130 by a predetermined distance and not to be separated outwardly from the space. A spring 141 may be disposed at a side (a top side in FIG. 14) of the elastic pin 140 and at an inner wall of the space to elastically support the elastic pin 140. Even when a user strongly press a touch screen with the stylus pen 100a, the elastic pin 140 can prevent damage to the touch screen or a display panel disposed below the touch screen. FIG. 14 illustrates that the elastic pin 140 is applied to the stylus pen of the embodiment shown in FIG. 1. However, it is intended for convenience of explanation, and thus, it should be understood that the elastic pin 140 may also be applied to the stylus pens of the embodiments shown in FIGS. 2 through 13.

In the above-described embodiments, a touch part of at least one of first and second touch pen portions may be made of a conductive material.

A touch screen including a resistive type touch sensor is operated under a pressure of a predetermined value or greater, and a touch screen including a capacitive type touch sensor is operated by contacting with a conductive object. In this regard, according to some embodiments of the present invention, when a touch part of at least one of first and second touch pen portions is made of a conductive material, the inventive stylus pen can be used on both a touch screen including a resistive type touch sensor and a touch screen including a capacitive type touch sensor.

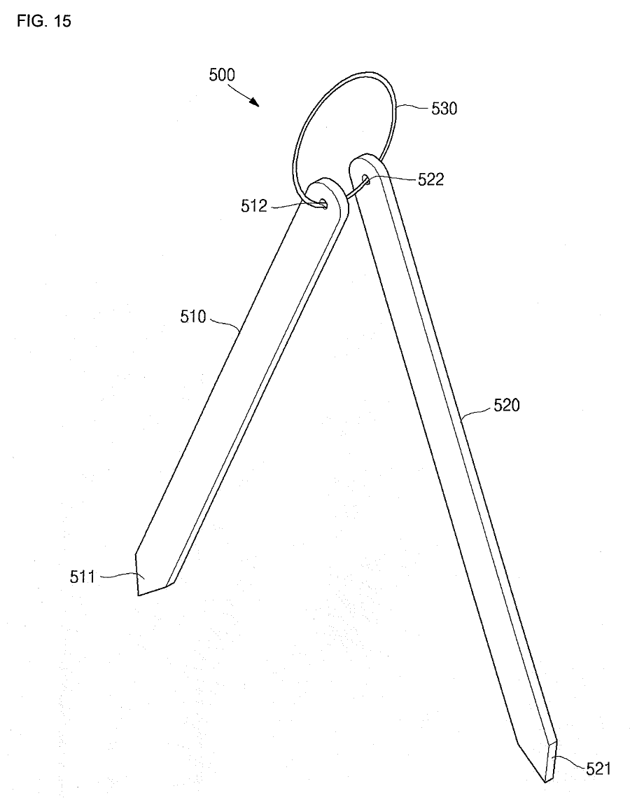

Meanwhile, a stylus pen according to a further embodiment of the present invention may be structured such that first and second touch pen portions are separated from each other. A detailed description thereof will now be provided with reference to FIG. 15.

FIG. 15 is a perspective view of a stylus pen 500 according to a further embodiment of the present invention.

Referring to FIG. 15, the stylus pen 500 includes first and second touch pen portions 510 and 520, and a coupling wire 530.

One ends of the first and second touch pen portions 510 and 520 have touch parts 511 and 521, and the other ends have through-holes 512 and 522.

Both ends of the coupling wire 530 are inserted into the through-holes 512 and 522 and connected to each other to link the first and second touch pen portions 510 and 520 so that the first and second touch pen portions 510 and 520 are approachably or separably moved with respect to each other along a predetermined length of the coupling wire 530. The coupling wire 530 may be made of any material capable of forming a wire, e.g., a thread, a ductile plastic, or a metal. More preferably, the coupling wire 530 may be made of a synthetic resin, such as nylon, which may not be disconnected with repeated use and be relatively lightweight.

The coupling wire 530 may have a diameter smaller than the through-holes 512 and 522 so as to be easily inserted into the through-holes 512 and 522.

At least one of the touch parts 511 and 521 of the first and second touch pen portions 510 and 520 may further include an elastic pin (not shown). The elastic pin is disposed at an end of at least one of the touch parts 511 and 521 to be elastically supported on the end. The elastic pin is as described above with reference to FIG. 14, and thus, a detailed description thereof will be omitted.

At least one of the touch parts 511 and 521 of the first and second touch pen portions 510 and 520 may be made of a conductive material. Therefore, the stylus pen 500 can be used on a touch screen including a capacitive type touch sensor as well as on a touch screen including a resistive type touch sensor.

As described above, the inventive stylus pen can simultaneously select two or more touch point positions on a touch screen by adjusting a spatial distance between touch parts.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A stylus pen comprising:
first and second touch pen portions, each of which comprises a touch part at an end thereof; and
a coupling portion linking the first and second touch pen portions so that the first and second touch pen portions are rotatably moved with respect to each other to adjust a spatial distance between the touch parts of the first and second touch pen portions.

2. The stylus pen of claim 1, wherein the touch parts of the first and second touch pen portions form a common tip when the first and second touch pen portions are integrally joined together.

3. The stylus pen of claim 2, wherein the first touch pen portion comprises a locking protrusion protruding toward the second touch pen portion, and the second touch pen portion comprises a locking groove receiving the locking protrusion to fixedly secure the first and second touch pen portions when the first and second touch pen portions are integrally joined together.

4. The stylus pen of claim 1, further comprising a compression spring for opening the first and second touch pen portions, both ends of the compression spring being fixed to positions of the first and second touch pen portions that are away from a rotation center of the touch pen portions.

5. The stylus pen of claim 1, further comprising a torsion spring disposed around the coupling portion to open the first and second touch pen portions, both ends of the torsion spring being fixed to the first and second touch pen portions.

6. The stylus pen of claim 5, wherein the torsion spring maintains the first and second touch pen portions at an angle of 180 degrees.

7. The stylus pen of claim 1, further comprising an angle retention member comprising:
a protrusion portion formed at a surface of the first touch pen portion facing the second touch pen portion and extending outwardly from the circumference of the rotation center of the first touch pen portion; and
a groove portion having a plurality of grooves formed at a predetermined pitch along an inner wall of a hollow space about the rotation center of the second touch pen portion to receive the protrusion portion whenever the first and second touch pen portions are rotatably moved with respect to each other by a predetermined angle, wherein the protrusion portion is elastically deformed to be elastically received in the groove portion.

8. The stylus pen of claim 1, further comprising an extension portion that is linked to the coupling portion coaxially with respect to the first and second touch pen portions and is rotatably moved with respect to the first and second touch pen portions.

9. The stylus pen of claim 8, further comprising a slide member that is slidably moved onto the extension portion and the first and second touch pen portions,
wherein when the slide member is slidably moved onto the first and second touch pen portions, the first and second touch pen portions are fully closed.

10. The stylus pen of claim 1, wherein an end of at least one of the touch parts of the first and second touch pen portions comprises an elastic pin that is elastically supported on the end.

11. The stylus pen of claim 1, wherein at least one of the touch parts of the first and second touch pen portions is made of a conductive material.

12. A stylus pen comprising:
first and second touch pen portions, each of which comprises a touch part at an end thereof and a through-hole at the other end; and
a coupling wire, both ends of which are inserted into the through-holes of the first and second touch pen portions and connected to each other, linking the first and second touch pen portions so that the first and second touch pen portions are approachably or separably moved with respect to each other along a predetermined length of the coupling wire.

13. The stylus pen of claim 12, wherein an end of at least one of the touch parts of the first and second touch pen portions comprises an elastic pin that is elastically supported on the end.

14. The stylus pen of claim 12, wherein at least one of the touch parts of the first and second touch pen portions is made of a conductive material.
